(19) United States
(12) Patent Application Publication
(10) Pub. No.: US 2024/0029663 A1
(43) Pub. Date: Jan. 25, 2024

(54) METHOD AND DEVICE FOR ESTABLISHING BRIGHTNESS CORRECTION DATABASE OF DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventors: Ling XU, Shenzhen (CN); Xinhong CHEN, Shenzhen (CN)

(21) Appl. No.: 17/887,460

(22) Filed: Aug. 14, 2022

(30) Foreign Application Priority Data
Jul. 21, 2022 (CN) 202210868619.9

(51) Int. Cl. G09G 3/34

(52) U.S. Cl. CPC G09G 3/3406; G09G 2320/0233; G09G 2320/0626

(57) ABSTRACT

Disclosed in the present application are a method and a device for establishing a brightness correction database of a display panel, and a method and a device for correcting brightness of a display panel. The method for establishing the brightness correction database of the display panel includes: acquiring brightness defect data of pixel units having brightness defects in a detected image of the display panel, and classifying the brightness defects of the pixel units based on the brightness defect data; fitting a plurality of brightness-grayscale curves according to brightness of the pixel units corresponding to different types of the brightness defects at different grayscales respectively; and obtaining brightness correction data of the pixel units corresponding to different types of the brightness defects respectively based on the plurality of brightness-grayscale curves to form the brightness correction database, which can improve speed and accuracy of brightness defect correction of the display panel.

### CROSS REFERENCE TO RELATED APPLICATIONS

This application claims the benefit of priority of CN 202210868619.9, filed Jul. 21, 2022, the contents of which are all incorporated herein by reference in its entirety.

### FIELD OF DISCLOSURE

The present application relates to a field of display technology, and more specifically, to a method and a device for establishing a brightness correction database of a display panel, and a method and a device for correcting brightness of a display panel.

### BACKGROUND

At present, in modern-day communication industry, demand for products such as mobile phones, televisions, tablets, notebooks, and digital cameras is increasing, and various display devices are also developing towards high resolution. As a result, overall brightness uniformity of display panels is also facing some new requirements.

In mass production of the display panels, it is inevitable that some process defects will lead to uneven brightness of the display panels, forming various brightness defects, for example, bright marks or dark marks. In order to solve technical problems of the brightness defects, brightness correction is usually used. However, in an actual production process, the brightness correction is slow and less accurate.

### SUMMARY

Embodiments of the present application provide a method and a device for establishing a brightness correction database of a display panel, and a method and a device for correcting brightness of a display panel, which can improve speed and accuracy of brightness defect correction of the display panel so as to improve brightness uniformity of the display panel.

On one hand, an embodiment of the present application provides a method for establishing a brightness correction database of a display panel, including: acquiring brightness defect data of pixel units having brightness defects in a detected image of the display panel, and classifying the brightness defects of the pixel units based on the brightness defect data; fitting a plurality of brightness-grayscale curves according to brightness of the pixel units corresponding to different types of the brightness defects at different grayscales respectively; and obtaining brightness correction data of the pixel units corresponding to different types of the brightness defects respectively based on the plurality of brightness-grayscale curves to form the brightness correction database.

Optionally, in some embodiments of the present application, the step of acquiring the brightness defect data of the pixel units having the brightness defects in the detected image of the display panel, and classifying the brightness defects of the pixel units based on the brightness defect data, specifically includes: acquiring the detected image of the display panel, and acquiring the brightness defect data of the pixel units having the brightness defects based on the detected image, wherein the brightness defect data includes defect feature attribute parameters; and classifying the brightness defects of the pixel units according to the defect feature attribute parameters.

Optionally, in some embodiments of the present application, the step of fitting the plurality of brightness-grayscale curves according to brightness of the pixel units corresponding to different types of the brightness defects at different grayscales respectively, specifically includes: acquiring brightness information of the pixel units having the brightness defects at different grayscales, recording brightness information of the pixel units corresponding to a same type of the brightness defects, respectively; and obtaining the plurality of brightness-grayscale curves according to the brightness information of the pixel units corresponding to different types of the brightness defects.

Optionally, in some embodiments of the present application, the step of obtaining the brightness correction data of the pixel units corresponding to different types of the brightness defects respectively based on the plurality of brightness-grayscale curves to form the brightness correction database, specifically include: respectively obtaining the brightness correction data of the pixel units corresponding to different types of the brightness defects, and respectively establishing brightness correction relationships of the pixel units corresponding to a same type of the brightness defects in different solid color screens at a same grayscale, and obtaining the brightness correction data of the pixel units corresponding to different types of the brightness defects in different solid color screens based on the brightness correction relationships.

Optionally, in some embodiments of the present application, the step of obtaining the brightness correction data of the pixel units corresponding to different types of the brightness defects respectively based on the plurality of brightness-grayscale curves to form the brightness correction database, specifically include: calculating respectively, based on the plurality of brightness-grayscale curves, grayscale correction values corresponding to each of the grayscale in a full grayscale range for the pixel units corresponding to different types of the brightness defects; and forming the brightness correction database of the pixel units corresponding to different types of the brightness defects on the basis of the grayscale correction values.

Optionally, in some embodiments of the present application, the defect feature attribute parameters include a name of a currently displayed screen, and/or an area, and/or a length, and/or a width, and/or an aspect ratio, and/or a central gray scale, and/or contrast, and/or coordinates, and/or brightness.

Optionally, in some embodiments of the present application, a method for correcting brightness of a display panel includes: acquiring a displayed image of the display panel, and identifying brightness defect types of pixel units having brightness defects in the displayed image; and performing brightness correction on the displayed image according to the brightness correction database obtained by the method for establishing the brightness correction database of the display panel as described in any one of embodiments of the present application.

Optionally, in some embodiments of the present application, the step of performing the brightness correction on the displayed image according to the brightness correction database obtained by the method for establishing the brightness correction database of the display panel as described above, specifically includes: obtaining the displayed image corresponding to a tie-point grayscale, and identifying the brightness defect types of the pixel units corresponding to the displayed image; matching and obtaining the brightness correction data in the full grayscale range in the brightness correction database according to the brightness defect types; and performing the brightness correction of the display panel based on the brightness correction data in the full grayscale range.

Optionally, in some embodiments of the present application, the step of performing the brightness correction on the displayed image according to the brightness correction database obtained by the method for establishing the brightness correction database of the display panel as described above, specifically includes: obtaining the displayed image corresponding to a tie-point grayscale, and identifying the brightness defect types of the pixel units corresponding to the displayed image; matching brightness defect types according to the brightness correction database to obtain brightness correction data between the tie-point grayscale and a next tie-point grayscale corresponding to the brightness defect types; and performing the brightness correction on the display panel according to brightness correction data between at least two tie-point grayscales.

An embodiment of the present application further provides a device for establishing a brightness correction database of a display panel, including: an acquisition module, a calculation module, and a correction module, wherein the acquisition module is configured to acquire brightness defect data of pixel units having brightness defects in a detected image of the display panel, and to classify the brightness defects of the pixel units based on the brightness defect data; the calculation module is configured to fit a plurality of brightness-grayscale curves according to brightness of the pixel units corresponding to different types of the brightness defects at different grayscales respectively; the correction module is configured to obtain brightness correction data of the pixel units corresponding to different types of the brightness defects respectively based on the plurality of brightness-grayscale curves to form the brightness correction database.

On another hand, an embodiment of the present application also provides a device for correcting the brightness of the display panel, including:
an acquisition module and a calculation-correction module, the acquisition module is configured to acquire a displayed image of the display panel and identify brightness defect types of pixel units having brightness defects in the displayed image; the calculation-correction module is configured to perform brightness correction on the displayed image according to the brightness correction database obtained by the method for establishing the brightness correction database of the display panel as described above.

### Advantages of Present Disclosure

Embodiments of the present application provide a method and a device for establishing a brightness correction database of a display panel, and a method and a device for correcting brightness of a display panel, wherein the method for establishing the brightness correction database of the display panel includes: acquiring brightness defect data of pixel units having brightness defects in a detected image of the display panel, and classifying the brightness defects of the pixel units based on the brightness defect data; fitting a plurality of brightness-grayscale curves according to brightness of the pixel units corresponding to different types of the brightness defects at different grayscales respectively; and obtaining brightness correction data of the pixel units corresponding to different types of the brightness defects respectively based on the plurality of brightness-grayscale curves to form the brightness correction database. By classifying brightness defects and establishing the brightness correction database including different brightness defect types, speed and accuracy of brightness defect correction of the display panel can be improved, so as to enhance brightness uniformity of the display panel, thereby improving a display effect.

### BRIEF DESCRIPTION OF DRAWINGS

To describe technical solutions in implementations of the present application more clearly, the following briefly introduces the accompanying drawings required for describing the implementations. The accompanying drawings in the following description illustrate some implementations of the present application. Those of ordinary skill in the art may also obtain other drawings based on these accompanying drawings without creative efforts.

FIG. 1 is a schematic flowchart of a method for establishing a brightness correction database of a display panel provided by an embodiment of the present application.

FIG. 2 is a schematic sub-flowchart of a step S10 in the method for establishing the brightness correction database of the display panel provided by the embodiment of the present application.

FIG. 3 is a schematic sub-flowchart of a step S20 in the method for establishing the brightness correction database of the display panel provided by the embodiment of the present application.

FIG. 4 is another schematic sub-flowchart of the step S20 in the method for establishing the brightness correction database of the display panel provided by the embodiment of the present application.

FIG. 5 is a schematic sub-flowchart of a step S30 in the method for establishing the brightness correction database of the display panel provided by the embodiment of the present application.

FIG. 6 is a schematic flowchart of a method for correcting brightness of the display panel provided by an embodiment of the present application.

FIG. 7 is a schematic sub-flowchart of a step S40 in the method for correcting the brightness of the display panel provided by the embodiment of the present application.

FIG. 8 is another schematic sub-flowchart of the step S40 in the method for correcting the brightness of the display panel provided by the embodiment of the present application.

FIG. 9 is a schematic structural diagram of a device for establishing the brightness correction database of the display panel provided by an embodiment of the present application.

FIG. 10 is a schematic structural diagram of a first structure of a correction device for the display panel provided by an embodiment of the present application.

FIG. 11 is a schematic structural diagram of a second structure of the correction device for the display panel provided by an embodiment of the present application.

### DETAILED DESCRIPTION OF PREFERRED EMBODIMENTS

Technical solutions in the implementations of the present application will be described clearly and completely hereinafter with reference to the accompanying drawings in the implementations of the present application. Apparently, the described implementations are merely some rather than all implementations of the present application. All other implementations obtained by those of ordinary skill in the art based on the implementations of the present application without creative efforts shall fall within the protection scope of the present application.

Embodiments of the present application provide a method and a device for establishing a brightness correction database of a display panel and a method and a device for correcting brightness of a display panel, which can improve speed and accuracy of brightness defect correction of the display panel so as to enhance brightness uniformity of the display panel. It should be noted that the description order in which the following embodiments are described is not intended to limit preferred order of the embodiments. In addition, in the description of the present application, the term “including” means “including but not limited to”. The terms “first”, “second”, “third”, etc. are used merely as indications to distinguish between different objects and not to describe a particular order.

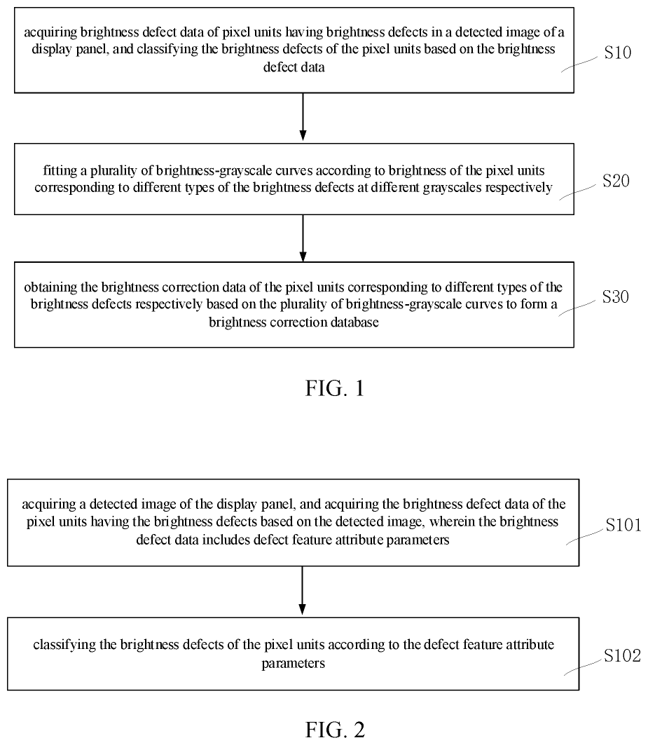

Please refer to FIG. 1. FIG. 1 is a schematic flowchart of a method for establishing a brightness correction database of a display panel provided by an embodiment of the present application. As shown in FIG. 1, the embodiment of the present application provides the method for establishing the brightness correction database of the display panel, including following steps:

S10: acquiring brightness defect data of pixel units having brightness defects in a detected image of the display panel, and classifying the brightness defects of the pixel units based on the brightness defect data.

In some embodiments, please refer to FIG. 2, which is a schematic sub-flowchart of a step S10 in the method for establishing the brightness correction database of the display panel provided by the embodiment of the present application. As shown in FIG. 2, the step S10 specifically includes following sub-steps:

S101: acquiring the detected image of the display panel, and acquiring the brightness defect data of the pixel units having the brightness defects based on the detected image, wherein the brightness defect data includes defect feature attribute parameters.

In the embodiment of the present application, the defect feature attribute parameters include a name of a currently displayed screen, and/or an area, and/or a length, and/or a width, and/or an aspect ratio, and/or a central gray scale, and/or contrast, and/or coordinates, and/or brightness.

In the embodiment of the present application, the brightness defect data further includes defect feature attribute gradient parameters including feature attribute gradient ranges of the brightness defect type and gradient coefficient factors corresponding to the feature attribute gradient ranges one to one. The defect feature attribute parameters are respectively substituted into the feature attribute gradient ranges to obtain gradient factor vectors, respectively.

S102: classifying the brightness defects of the pixel units according to the defect feature attribute parameters.

S20: fitting a plurality of brightness-grayscale curves according to brightness of the pixel units corresponding to different types of the brightness defects at different grayscales respectively.

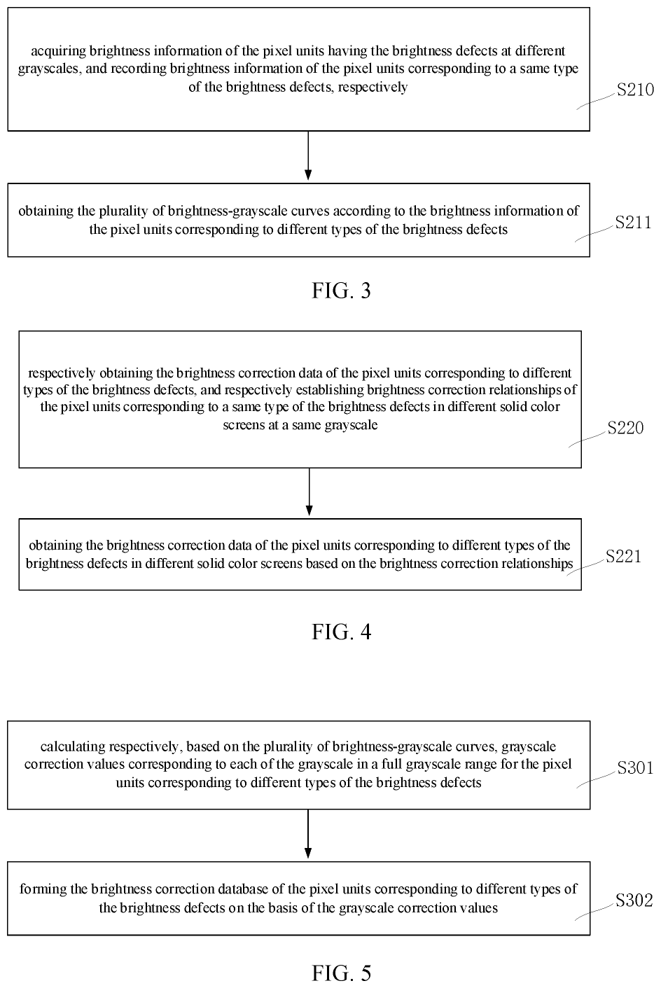

In some embodiments, please refer to FIG. 3, which is a schematic sub-flowchart of a step S20 in the method for establishing the brightness correction database of the display panel provided by the embodiment of the present application. As shown in FIG. 3, the step S20 specifically includes following sub-steps:

S210: acquiring brightness information of the pixel units having the brightness defects at different grayscales, and recording brightness information of the pixel units corresponding to a same type of the brightness defects, respectively.

Specifically, brightness of pixel units corresponding to each grayscale in a full grayscale range are obtained respectively for the pixel units corresponding to the same type of the brightness defects.

S211: obtaining the plurality of brightness-grayscale curves according to the brightness information of the pixel units corresponding to different types of the brightness defects.

As a specific implementation manner of the present application, please refer to FIG. 4. FIG. 4 is another schematic sub-flowchart of the step S20 in the method for establishing the brightness correction database of the display panel provided by the embodiment of the present application. As shown in FIG. 4, the step S20 specifically includes following sub-steps:

S220: respectively obtaining the brightness correction data of the pixel units corresponding to different types of the brightness defects, and respectively establishing brightness correction relationships of the pixel units corresponding to a same type of the brightness defects in different solid color screens at a same grayscale.

Specifically, since brightness defects behave differently in different color channels, the brightness correction relationship between brightness defects in different solid color screens can be established. For example, the relationship between brightness correction value in a green screen and brightness correction value in a red screen and/or a blue screen is established, so as to achieve an effect of monochrome photo compensation for color mixing, and thus reduce an adjustment time of panel chromaticity uniformity.

S221: obtaining the brightness correction data of the pixel units corresponding to different types of the brightness defects in different solid color screens based on the brightness correction relationships.

Further, the brightness correction data of the pixel units corresponding to different types of the brightness defects under each grayscale in the full grayscale range in different solid color screens are generated by the brightness correction relationship of the same type of the brightness defects in different solid color screens at the same grayscale. For example, the brightness correction data of the pixel units corresponding to a defect A in the red screen, the green screen, and the blue screen are obtained, and based on three brightness correction data obtained, the brightness correction data corresponding to the brightness defects in a detected screen is calculated according to a proportional relationship of a color mixing between a color of the detected screen and/or the red screen, the green screen, and the blue screen. If the detected screen is a purple screen, the brightness correction data corresponding to the bright defects in the purple screen is calculated according to the proportional relationship of the color mixing between the purple screen and the red screen, the green screen, and the blue screen.

S30: obtaining the brightness correction data of the pixel units corresponding to different types of the brightness defects respectively based on the plurality of brightness-grayscale curves to form the brightness correction database.

In some embodiments, please refer to FIG. 5, which is a schematic sub-flowchart of a step S30 in the method for establishing the brightness correction database of the display panel provided by the embodiment of the present application. As shown in FIG. 5, the step S30 specifically includes following sub-steps:

S301: calculating respectively, based on the plurality of brightness-grayscale curves, grayscale correction values corresponding to each of the grayscale in a full grayscale range for the pixel units corresponding to different types of the brightness defects.

S302: forming the brightness correction database of the pixel units corresponding to different types of the brightness defects on the basis of the grayscale correction values.

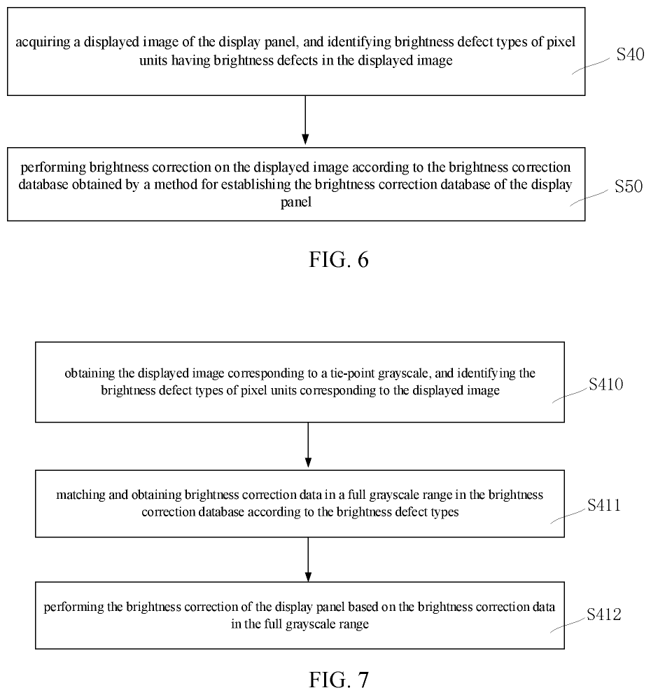

On another hand, the present application further provides a method for correcting brightness of a display panel. Please refer to FIG. 6, which is a schematic flowchart of a method for correcting brightness of the display panel provided by an embodiment of the present application. As shown in FIG. 6, the method for correcting the brightness of the display panel includes following steps:

S40: acquiring a displayed image of the display panel, and identifying brightness defect types of pixel units having brightness defects in the displayed image.

Please refer to FIG. 7, which is a schematic sub-flowchart of a step S40 in the method for correcting the brightness of the display panel provided by the embodiment of the present application. As shown in FIG. 7, a specific process includes:

S410: obtaining the displayed image corresponding to a tie-point grayscale, and identifying the brightness defect types of pixel units corresponding to the displayed image.

A neural network based on the brightness correction database enables accurate brightness correction of a single tie-point, which helps improve correction accuracy and reduce time required for correction.

S411: matching and obtaining brightness correction data in a full grayscale range in the brightness correction database according to the brightness defect types.

S412: performing the brightness correction of the display panel based on the brightness correction data in the full grayscale range, so as to minimize a brightness correction time to a greatest extent and improve production efficiency.

Specifically, after the step of performing the brightness correction of the display panel based on the brightness correction data in the full grayscale range, the method further includes steps of burning and photographing-determining, wherein the burning is to burn the brightness correction data of the tie-point grayscale into the brightness correction database. The photographing-determining is to take a picture of the displayed image with correction information to determine a level of the display panel. When brightness defects in a corrected displayed image are eliminated, a brightness correction process is completed.

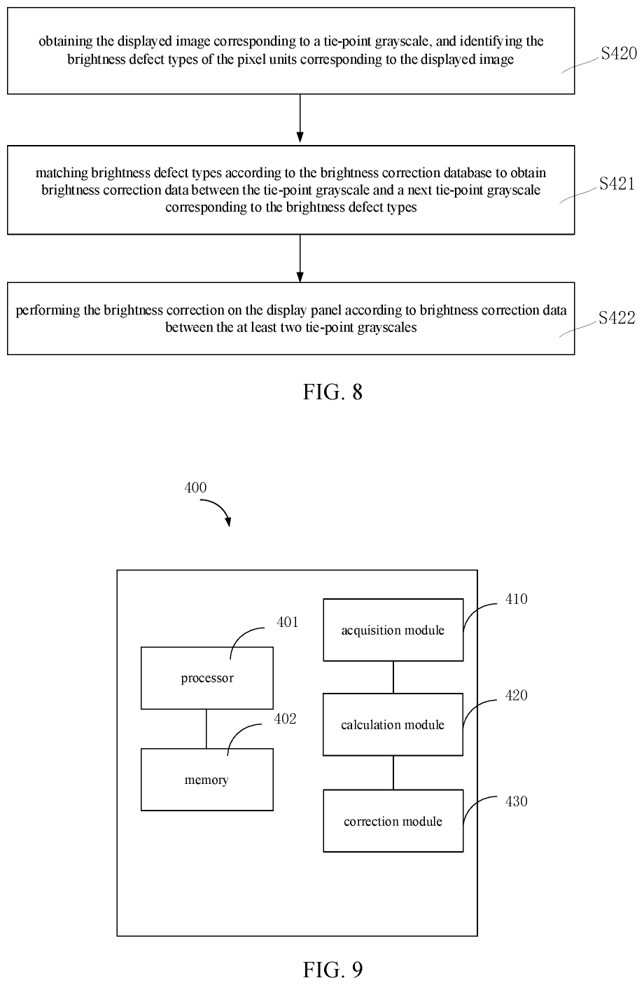

As a specific implementation manner of the present application, please refer to FIG. 8, which is another schematic sub-flowchart of the step S40 in the method for correcting the brightness of the display panel provided by the embodiment of the present application. As shown in FIG. 8, a specific process includes:

S420: obtaining the displayed image corresponding to a tie-point grayscale, and identifying the brightness defect types of the pixel units corresponding to the displayed image.

Specifically, in some embodiments, at least two tie-point grayscales are selected when taking pictures, and the displayed image corresponding to at least one set of the tie-point grayscales is obtained. Specifically, selected tie-point grayscales respectively are 25 grayscales, 60 grayscales, and 128 grayscales as examples. It should be noted that, those skilled in the art may select a number of tie-point grayscales according to characteristics of the display panel, which is not limited in the present application.

S421: matching brightness defect types according to the brightness correction database to obtain brightness correction data between the tie-point grayscale and a next tie-point grayscale corresponding to the brightness defect types.

Specifically, a displayed image of 60 grayscales is photographed, and the brightness defects of the pixel units in the displayed image are matched with stored brightness defect types.

S422: performing the brightness correction on the display panel according to brightness correction data between the at least two tie-point grayscales, thereby minimizing the brightness correction time to a greatest extent and improving the production efficiency.

Specifically, the brightness correction data are matched based on the brightness defect types, the brightness correction data of each grayscale between the at least two tie-point grayscales is called. For example, the brightness correction data corresponding a type of brightness defect from 60 grayscales to 128 grayscales is called. This method reduces a calculation time for interpolation, and since the brightness correction data used for brightness defect is correction data for each grayscale measured in the step described above, compensation obtained is more accurate than a tradition linear interpolation of brightness defects, and the brightness correction time is minimized to a greatest extent, and the production efficiency is improved.

S50: performing brightness correction on the displayed image according to the brightness correction database obtained by the method for establishing the brightness correction database of the display panel as described above.

Further, after the step of performing the brightness correction of the display panel based on the brightness correction data between the at least two tie-point grayscales, the method further includes steps of burning and photographing-determining, wherein the burning is to burn the brightness correction data of the tie-point grayscale into the brightness correction database. The photographing-determining is to take a picture of the displayed image with correction information to determine the level of the display panel. When the brightness defects in the corrected displayed image are eliminated, the brightness correction process is completed.

Wherein, the displayed image of the display panel is acquired as follows:

(1) erasing an image residue of the display panel so that the display panel is in an initial state.

Wherein the display panel has the image residue. Therefore, if the displayed image of the display panel is directly acquired, it will lead to an error between brightness of an acquired displayed image and actual brightness. This will affect the accuracy of the brightness correction of the display panel. Therefore, before acquiring the displayed image of the display panel, an erasing operation is required to erase the image residue of the display panel to make the display panel in the initial state, thereby preventing the image residue of the display panel from affecting accuracy of subsequent brightness correction of the display panel.

(2) Delivering a white screen to the display panel.

Wherein in the embodiment of the present application, the brightness of the display panel is corrected, and color is not corrected. Therefore, only grayscale screen needs to be detected. Therefore, a white screen with a fixed grayscale is delivered to the display panel, and the brightness of the white screen is measured. Wherein the fixed grayscale may be one of 0, 24, 32, 64, 96, 128, 225, and 255 grayscales.

(3) Obtaining brightness data of the displayed image when the display panel is displaying the white screen.

Wherein, the brightness information of the pixel units corresponding to the displayed image is obtained, and a display region of the display panel is divided to calculate the brightness of the pixel units located in a central region and the brightness of the pixel units located in other regions, which may be as follows:

obtaining a central point of the central region, dividing a plurality of other sub-regions around the central region, and obtaining central points of the other sub-regions.

It should be noted that the central point of the center region is a geometric center of the center region, that is, an intersection of two diagonal lines of the center region. The central point of the other sub-regions is a geometric center of the other sub-regions, that is, an intersection of two diagonal lines of the other sub-regions. The brightness of the displayed image can be obtained by means of a color analyzer. Specifically, CA310 or CA410 may be used to obtain the brightness of the displayed image. The brightness of the central point of the central region or the other sub-regions is measured by making a probe of the CA310 or the CA410 point towards the central point of the central region or the other sub-regions and perpendicular to the central region or other sub-regions.

The method for correcting the brightness of the display panel provided by the present application classifies the brightness defects, and establishes a plurality of brightness-grayscale curves corresponding to the brightness defect types for brightness variation trends of different types of the brightness defects in the full grayscale range, and then calculates the brightness correction data corresponding to the brightness defect types, and uses corresponding brightness correction data to fit brightness correction data between tie-points after taking pictures to identify the tie-point grayscales, so as to improve the speed and accuracy of the brightness defect correction of the display panel and to improve the brightness uniformity of the display panel, thereby improving the display effect.

Please refer to FIG. 9. FIG. 9 is a schematic structural diagram of a device for establishing the brightness correction database of the display panel provided by an embodiment of the present application. As shown in FIG. 9, the embodiment of the present application further provides a device 400 for establishing the brightness correction database of the display panel, including: an acquisition module 410, a calculation module 420, and a correction module 430, and specifics are as follows:

the acquisition module 410 is configured to acquire brightness defect data of pixel units having brightness defects in a detected image of the display panel, and to classify the brightness defects of the pixel units based on the brightness defect data.

The calculation module 420 is configured to fit a plurality of brightness-grayscale curves according to brightness of the pixel units corresponding to different types of the brightness defects at different grayscales respectively.

The correction module 430 is configured to obtain brightness correction data of the pixel units corresponding to different types of the brightness defects respectively based on the plurality of brightness-grayscale curves to form the brightness correction database.

The device 400 also includes a processor 401 and a memory 402, the processor 401 is electrically connected to the memory 402; the memory 402 is configured to store instructions and data, and the processor 401 is configured to implement steps in a method for establishing a brightness correction database of the display panel, and the method for establishing the brightness correction database of the display panel includes following steps:
acquiring brightness defect data of pixel units having brightness defects in a detected image of the display panel, and classifying the brightness defects of the pixel units based on the brightness defect data;
fitting a plurality of brightness-grayscale curves according to brightness of the pixel units corresponding to different types of the brightness defects at different grayscales respectively; and
obtaining brightness correction data of the pixel units corresponding to different types of the brightness defects respectively based on the plurality of brightness-grayscale curves to form a brightness correction database.

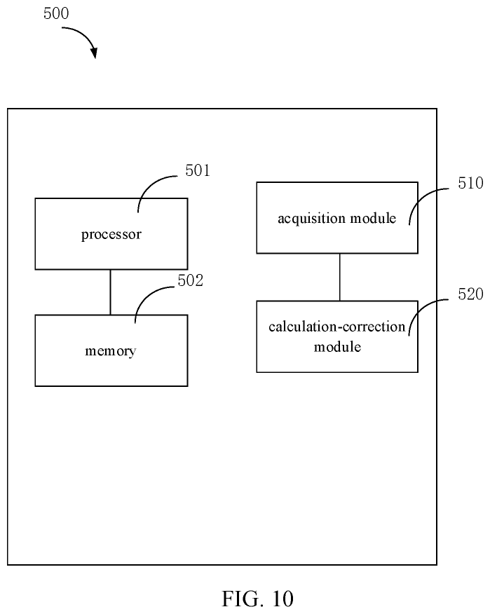

Please refer to FIG. 10. FIG. 10 is a schematic structural diagram of a first structure of a correction device for the display panel provided by an embodiment of the present application. As shown in FIG. 10, the embodiment of the present application further provides the correction device 500 for correcting the brightness of the display panel, including: an acquisition module 510 and a calculation-correction module 520, and specifics are as follows:
the acquisition module 510 is configured to acquire a displayed image of the display panel and identify brightness defect types of pixel units having brightness defects in the displayed image.
The calculation-correction module 520 is configured to perform a brightness correction on the displayed image according to the brightness correction database obtained by the method for establishing the brightness correction database of the display panel as described above.

The correction device 500 also includes a processor 501 and a memory 502, the processor 501 is electrically connected to the memory 502; the memory 502 is configured to store instructions and data, and the processor 501 is configured to implement steps in the method for correcting the brightness of the display panel, the method for correcting the brightness of the display panel includes following steps:
acquiring a displayed image of a display panel, and identifying brightness defect type of pixel units having brightness defects in the displayed image; and
performing a brightness correction on the displayed image according to the brightness correction database obtained by the method for establishing the brightness correction database of the display panel.

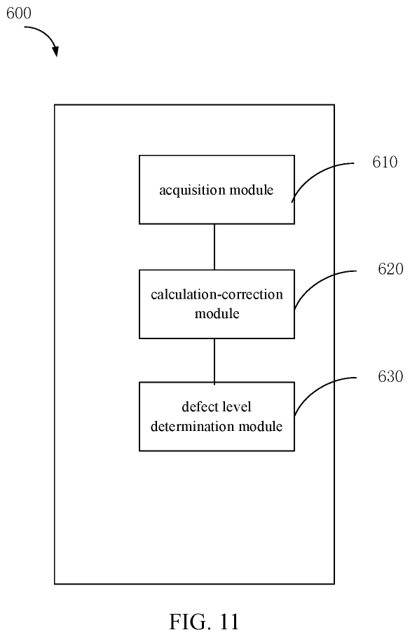

Please refer to FIG. 11. FIG. 11 is a schematic structural diagram of a second structure of the correction device for the display panel provided by an embodiment of the present application. A difference between the correction device 600 shown in FIG. 11 and the correction device 500 shown in FIG. 10 is that the correction device 600 includes an acquisition module 610, a calculation-correction module 620, and a defect-level determination module 630. The defect level determination module 630 is configured to determine a level of the display panel according to a number of identified brightness defects and brightness defect types.

Embodiments of the present application provide a method and a device for establishing a brightness correction database of a display panel, and a method and a device for correcting brightness of a display panel, wherein the method for establishing the brightness correction database of the display panel includes: acquiring brightness defect data of pixel units having brightness defects in a detected image of the display panel, and classifying the brightness defects of the pixel units based on the brightness defect data; fitting a plurality of brightness-grayscale curves according to brightness of the pixel units corresponding to different types of the brightness defects at different grayscales respectively; and obtaining brightness correction data of the pixel units corresponding to different types of the brightness defects respectively based on the plurality of brightness-grayscale curves to form the brightness correction database. By classifying the brightness defects and establishing the brightness correction database including different brightness defect types, speed and accuracy of brightness defect correction of the display panel can be improved, so as to enhance brightness uniformity of the display panel, thereby improving a display effect.

The method and the device for establishing the brightness correction database of the display panel, and the method and the device for correcting the brightness of the display panel provided in the embodiments of the present application have been described in detail above. The specific examples herein are utilized to illustrate the principles and embodiments of the application. The description of the embodiments above is designed to assist in understanding the method and ideas of the present application. At the same time, persons skilled in the art could, based on the ideas in the application, make alterations to the specific embodiments and application scope, and thus the content of the present specification should not be construed as placing limitations on the present application.

1. A method for establishing a brightness correction database of a display panel, comprising:
acquiring brightness defect data of pixel units having brightness defects in a detected image of the display panel, and classifying the brightness defects of the pixel units based on the brightness defect data;
fitting a plurality of brightness-grayscale curves according to brightness of the pixel units corresponding to different types of the brightness defects at different grayscales respectively; and
obtaining brightness correction data of the pixel units corresponding to different types of the brightness defects respectively based on the plurality of brightness-grayscale curves to form the brightness correction database;
wherein the step of acquiring the brightness defect data of the pixel units having the brightness defects in the detected image of the display panel, and classifying the brightness defects of the pixel units based on the brightness defect data comprises:
acquiring the detected image of the display panel, and acquiring the brightness defect data of the pixel units having the brightness defects based on the detected image, wherein the brightness defect data comprises defect feature attribute parameters; and
classifying the brightness defects of the pixel units according to the defect feature attribute parameters, the defect feature attribute parameters comprising a name of a currently displayed screen, and/or an area, and/or a length, and/or a width, and/or an aspect ratio, and/or a central gray scale, and/or contrast, and/or coordinates, and/or brightness,
the brightness defect data further comprises defect feature attribute gradient parameters.

2. (canceled)

3. The method as claimed in claim 1, wherein the step of fitting the plurality of brightness-grayscale curves according to brightness of the pixel units corresponding to different types of the brightness defects at different grayscales respectively comprises:
acquiring brightness information of the pixel units having the brightness defects at different grayscales, recording brightness information of the pixel units corresponding to a same type of the brightness defects, respectively; and
obtaining the plurality of brightness-grayscale curves according to the brightness information of the pixel units corresponding to different types of the brightness defects.

4. The method as claimed in claim 1, wherein the step of obtaining the brightness correction data of the pixel units corresponding to different types of the brightness defects respectively based on the plurality of brightness-grayscale curves to form the brightness correction database comprises:
respectively obtaining the brightness correction data of the pixel units corresponding to different types of the brightness defects, and respectively establishing brightness correction relationships of the pixel units corresponding to a same type of the brightness defects in different solid color screens at a same grayscale; and
obtaining the brightness correction data of the pixel units corresponding to different types of the brightness defects in different solid color screens based on the brightness correction relationships.

5. The method as claimed in claim 1, wherein the step of obtaining the brightness correction data of the pixel units corresponding to different types of the brightness defects respectively based on the plurality of brightness-grayscale curves to form the brightness correction database comprises:
calculating respectively, based on the plurality of brightness-grayscale curves, grayscale correction values corresponding to each of the grayscale in a full grayscale range for the pixel units corresponding to different types of the brightness defects; and
forming the brightness correction database of the pixel units corresponding to different types of the brightness defects on the basis of the grayscale correction values.

6. (canceled)

7. A method for correcting brightness of the display panel, comprising:
acquiring a displayed image of the display panel, and identifying brightness defect types of pixel units having brightness defects in the displayed image; and
performing brightness correction on the displayed image according to the brightness correction database obtained by the method for establishing the brightness correction database of the display panel as described in claim 1.

8. The method as claimed in claim 7, wherein the step of performing the brightness correction on the displayed image according to the brightness correction database obtained by the method for establishing the brightness correction database of the display panel comprises:
obtaining the displayed image corresponding to a tie-point grayscale, and identifying the brightness defect types of the pixel units corresponding to the displayed image;
matching and obtaining brightness correction data in a full grayscale range in the brightness correction database according to the brightness defect types; and
performing the brightness correction of the display panel based on the brightness correction data in the full grayscale range.

9. The method as claimed in claim 7, wherein the step of performing the brightness correction on the displayed image according to the brightness correction database obtained by the method for establishing the brightness correction database of the display panel comprises:
obtaining the displayed image corresponding to a tie-point grayscale, and identifying the brightness defect types of the pixel units corresponding to the displayed image;
matching brightness defect types according to the brightness correction database to obtain brightness correction data between the tie-point grayscale and a next tie-point grayscale corresponding to the brightness defect types; and
performing the brightness correction on the display panel according to brightness correction data between at least two tie-point grayscales.

10. A device for establishing a brightness correction database of a display panel, comprising:
a processor and a memory, the processor electrically connected to the memory, the memory configured to store instructions and data, and the processor configured to implement steps in a method for establishing the brightness correction database of the display panel, and the method for establishing the brightness correction database of the display panel comprising following steps:
acquiring brightness defect data of pixel units having brightness defects in a detected image of the display panel, and classifying the brightness defects of the pixel units based on the brightness defect data;
fitting a plurality of brightness-grayscale curves according to brightness of the pixel units corresponding to different types of the brightness defects at different grayscales respectively; and
obtaining brightness correction data of the pixel units corresponding to different types of the brightness defects respectively based on the plurality of brightness-grayscale curves to form the brightness correction database;
wherein the step of acquiring the brightness defect data of the pixel units having the brightness defects in the detected image of the display panel, and classifying the brightness defects of the pixel units based on the brightness defect data comprises:
acquiring the detected image of the display panel, and acquiring the brightness defect data of the pixel units having the brightness defects based on the detected image, wherein the brightness defect data comprises defect feature attribute parameters; and
classifying the brightness defects of the pixel units according to the defect feature attribute parameters, the defect feature attribute parameters comprising a name of a currently displayed screen, and/or an area, and/or a length, and/or a width, and/or an aspect ratio, and/or a central gray scale, and/or contrast, and/or coordinates, and/or brightness,
the brightness defect data further comprises defect feature attribute gradient parameters.
